(19) United States
(12) Patent Application Publication
(10) Pub. No.: US 2007/0085399 A1
(43) Pub. Date: Apr. 19, 2007

(54) Vehicle seat adjuster mechanism

(75) Inventors: John F. Nathan, White Lake, MI (US); Steven A. Schulte, Novi, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation

(21) Appl. No.: 11/242,490

(22) Filed: Oct. 3, 2005

(51) Int. Cl. B60N 2/225

(52) U.S. Cl. 297/362

(57) ABSTRACT

A rotary adjuster, such as for a vehicle seat having a seat back rotable relative to a seat bottom, includes a first member defining first and second cam surfaces. A second member is rotatably mounted relative to the first member about an axis. The second member defines third and fourth cam surfaces. The third cam surface faces the first cam surface and defines a first gap therebetween. The fourth cam surface faces the second cam surface and defines a second gap therebetween. A first wedge element is disposed in the first gap so as be selectively movable between a wedged position engaging the first and third cam surfaces to prevent rotation of the second member relative to the first member in a first rotational direction, and a free position permitting movement of the second member relative to the first member. A second wedge element is disposed in the second gap so as to be selectively movable between a wedged position engaging the second and fourth cam surfaces to prevent rotation of the second member relative to the first member in a second rotational direction opposite the first rotational direction, and a free position permitting movement between the second member relative to the first member. An actuation mechanism responsive to a radially directed force for moving at least one of the first and second wedge elements from the wedged position to the free position, thereby allowing the rotational position of the second member to be adjusted relative to the first member.

### BACKGROUND OF THE INVENTION

This invention relates in general to vehicle seats and in particular to a seat recliner for adjusting the rotational position of one portion of a seat to another portion of a seat, e.g., the seat back relative to the seat bottom.

Most vehicle seats, particularly in passenger vehicles, are generally provided with adjustment mechanisms to allow the occupant to position the seat for optimal comfort. A vehicle seat typically includes a seat back that is pivotably mounted to a seat bottom. Many vehicle seats also include a recliner mechanism to adjust the angle of the seat back relative to the seat bottom. The recliner mechanism can be manually operated or electrically powered. Conventionally, these recliner mechanisms included selectively engaged toothed members for angularly positioning the seat back relative to the seat bottom in angular increments corresponding to the pitch of the teeth. Although these types of recliners have been suitable in the past, it is often desirable to adjust the recliner mechanism so that the seat back may be at any desired angular position instead of at the discrete angular position corresponding to the position of the toothed members.

### BRIEF SUMMARY OF THE INVENTION

This invention relates to a rotary adjuster such as for use in a seat recliner for adjusting the position of a seat back relative to a seat bottom. The adjuster includes a first member defining first and second cam surfaces. A second member is rotatably mounted relative to the first member about an axis. The second member defines third and fourth cam surfaces. The third cam surface faces the first cam surface and defines a first gap therebetween. The fourth cam surface faces the second cam surface and defines a second gap therebetween. A first wedge element is disposed in the first gap so as be selectively movable between a wedged position, engaging the first and third cam surfaces to prevent rotation of the second member relative to the first member in a first rotational direction, and a free position, permitting movement of the second member relative to the first member. A second wedge element is disposed in the second gap so as to be selectively movable between a wedged position, engaging the second and fourth cam surfaces to prevent rotation of the second member relative to the first member in a second rotational direction opposite the first rotational direction, and a free position, permitting movement between the second member relative to the first member. An actuation mechanism is responsive to a radially directed force for moving at least one of the first and second wedge elements from the wedged position to the free position, thereby allowing the rotational position of the second member to be adjusted relative to the first member.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a vehicle seat including a first embodiment of an adjuster in accordance with the present invention.

FIG. 2 is an enlarged partial cross-sectional view of the adjuster of FIG. 1.

FIG. 3 is an enlarged partial cross-sectional view of a portion of the adjuster shown in FIG. 1, wherein the adjuster is illustrated in its locked position.

FIG. 4 is a cross-sectional view of the adjuster taken along circumferential lines 4-4 of FIG. 3.

FIG. 5 is an enlarged partial cross-sectional view of a portion of the adjuster shown in FIG. 1, wherein the adjuster is illustrated in its unlocked position.

FIG. 6 is a partial cross-sectional view of an alternate embodiment of an adjuster, illustrated in its locked position.

FIG. 7 is a partial cross-sectional view of the adjuster of FIG. 6, illustrated in its unlocked position.

FIG. 8 is a partial cross-sectional view of another alternate embodiment of an adjuster, illustrated in its locked position.

FIG. 9 is a partial cross-sectional view of the adjuster of FIG. 8, illustrated in its unlocked position.

FIG. 10 is cross-sectional view of yet another embodiment of an adjuster taken through the contact points of the wedge element with the outer and inner members.

FIG. 11 is a cross-sectional view of an alternate embodiment of a locking assembly.

### DETAILED DESCRIPTION OF THE INVENTION

Referring now to the drawings, there is illustrated in FIG. 1 a vehicle seat, indicated generally at 10. The seat 10 includes a seat bottom 14, a seat back 12, and a headrest 16. The seat back 12 is pivotally mounted relative to the seat bottom 14. A recliner or adjuster, indicated generally at 20, is connected to the seat bottom 14 and the seat back 12. As will be explained in detail below, the adjuster 20 is operable between a locked position for preventing pivotal motion of the seat back 12 relative to the seat bottom 14, and an unlocked position for permitting pivotal motion of the seat back 12 relative to the seat bottom 14. When the adjuster 20 is in its unlocked state, the occupant of the seat or other user may adjust the angle of the seat back relative to the seat bottom 14. After the occupant has moved the seat back 12 to a desired position, the adjuster 20 can be operated to its locked position, thereby fixing the seat back 12 at its desired position relative to the seat bottom 14.

Although the adjuster 20 is ideally suited for use in selectively locking the seat back 12 relative to the seat bottom 14, it should be understood that the adjuster 20 can be used with other seat components or for any suitable assembly arrangement wherein one component is selectively pivotal relative to a second component. For example, the headrest 16 may be pivotally mounted relative to the seat back 12. An adjuster, such as the adjuster 20 or any other embodiment of an adjuster disclosed herein, may be used in selectively locking the headrest 16 relative to the seat back 12.

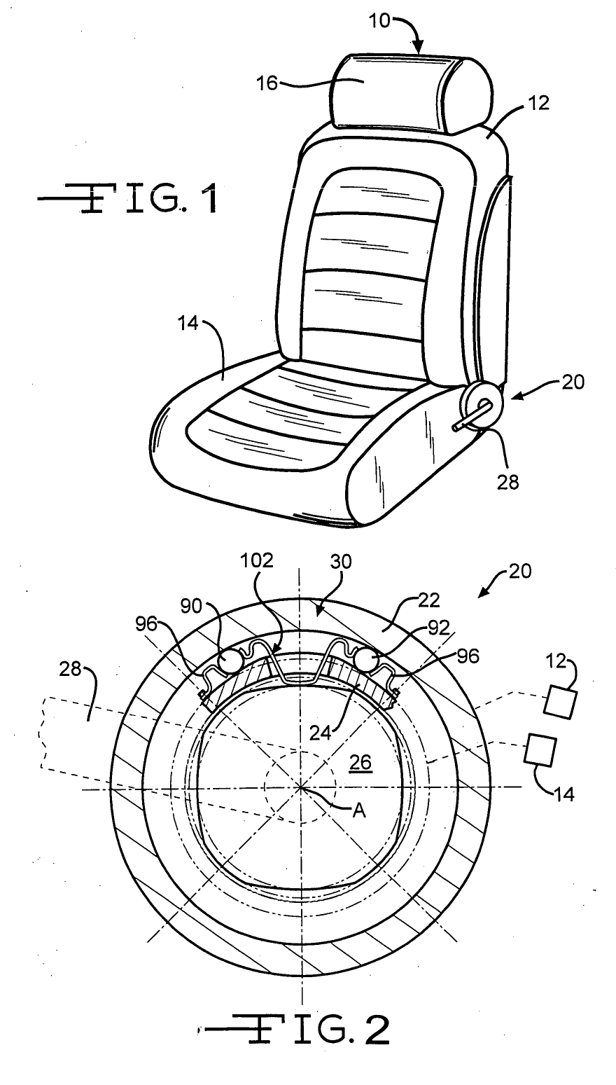

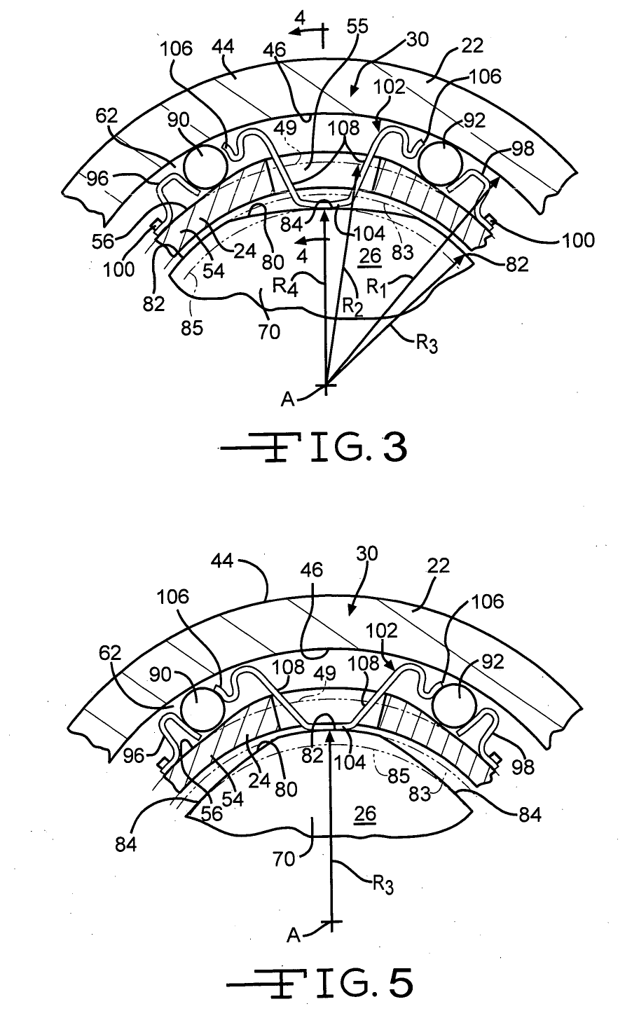

As shown in FIG. 2, the adjuster 20 generally includes a first or outer member 22, a second or inner member 24, a cam member 26, a handle 28, and a plurality of locking assemblies, indicated generally at 30. The outer member 22 is connected to one of the seat bottom 14 and the seat back 12, and the inner member 24 is connected to the other of the seat bottom 14 and the seat back 12. For simplicity in describing the invention, the outer member 22 will be described as being connected to the seat back 12, and the inner member 24 will be described as being connected to the seat bottom 14, as schematically indicated in FIG. 2. The outer and inner members 22 and 24 can be connected to the respective seat back 12 and seat bottom 14 by any suitable manner.

The outer member 22 is rotatably mounted relative to the inner member 24. Preferably, the outer and inner members 22 and 24 rotate along a common axis A. The outer member 22 and the inner member 24 can be rotatably mounted relative to one another by any suitable manner. In the embodiment of the adjuster shown in FIGS. 2-5, the outer and inner members 22 and 24 are rotatably mounted relative to one another via a mounting on the cam member 26, as will be discussed in detail below. However, it should be understood that the outer and inner members 22 and 24 may be otherwise rotatably mounted relative to one another, such as by being mounted on an axle or another component (not shown) or rotatably mounted directly theretogether. The cam member 26 also preferably is rotatably mounted about the axis A, but it is not required. Thus, the outer member 22, the inner member 24, and the cam member 26 may be offset from one another and rotate about non-coaxial axes.

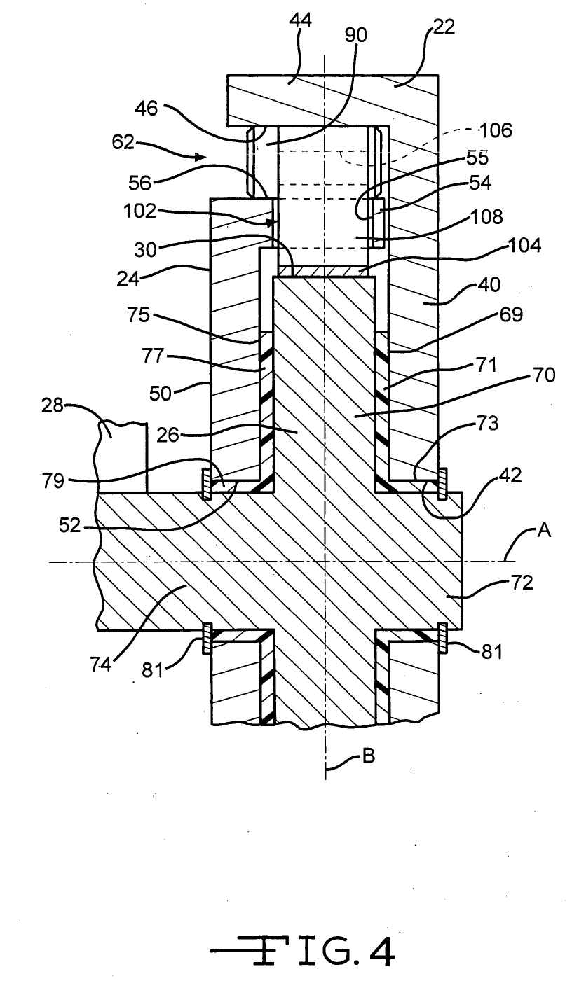

As best shown in FIG. 4, the outer member 22 includes a central portion 40 having a hole 42 formed therethrough. The outer member 22 further includes an outer flange 44 formed about the periphery thereof. The outer flange 44 extends axially from the peripheral edge of the central portion 40. The outer flange 44 defines a generally cylindrical inner surface 46. In the embodiment of the inner surface 46 as shown in FIGS. 2, 3, and 5, the inner surface 46 is preferably a circular cylindrical surface having a constant radial dimension R₁ therealong.

The inner member 24 is similar in shape as the outer member 22. The inner member 24 includes a central portion 50 having a hole 52 formed therethrough. The inner member 24 further includes an outer flange 54 formed about the periphery thereof. The outer flange 54 extends axially from the peripheral edge of the central portion 50. A plurality of radially extending openings 55 are formed in the outer flange 54. The outer flange 54 defines a generally cylindrical outer surface 56. In the embodiment of the outer surface 56 as shown in FIGS. 2, 3 and 5, the outer surface 56 generally has a cylindrical surface. However, unlike the inner surface 46 of the outer member 22, the outer surface 56 of the inner member 24 does not have a constant radial dimension therealong but rather defines a plurality of cam surfaces having different radial dimensions. For clarity purposes there is illustrated by phantom line 49 a constant radial dimension R₂ as shown in FIG. 3. An annular gap 62 is defined between the inner surface 46 of the outer member 22 and the outer surface 56 of the inner member 24. Due to the non-constant radial dimension of the outer surface 56, the radial width of the annular gap 62 is not uniform. Thus, the annular gap 62 defines multiple gaps having different radial dimensions. The purpose of the annular gap 62 will be described in detail below.

As best shown in FIG. 4, the cam member 26 includes a disc shaped central portion 70. A first stem 72 extends axially outwardly from the central portion 70. A second stem 74 extends axially outwardly from the central portion 70 in the opposite direction from the first stem 72. The outer member 22 is rotatably mounted on the cam member 26. The first stem 72 is received in the hole 42 of the central portion 40 of the outer member 22. An optional washer 69 having a thrust washer portion 71 and a bushing portion 73 may be used between the outer member 22 and cam member 26 to provide rotational support therebetween. In a similar manner, the inner member 24 is rotatably mounted on the cam member 26. The second stem 74 is received in the hole 52 of the central portion 50 of the inner member 24. An optional washer 75 having a thrust washer portion 77 and a bushing portion 79 may be used between the inner member 24 and cam member 26 to provide rotational support therebetween. Circlips 81 may be used to retain the outer and inner members 22 and 24 to the cam member 26. It should be understood that the outer and inner members 22 and 24 may be rotatably mounted on the cam member 26 by any suitable manner other than as shown in the figures.

The central portion 70 of the cam member 28 includes a generally outer cylindrical surface 80. The surface 80 does not have a constant radial dimension therealong, but rather defines a plurality of cam surfaces having different radial dimensions from the axis A. These plurality of cam surfaces include a plurality of peak surfaces 82 at a radial dimension R₃, indicated by phantom line 83, and a plurality of valley surfaces 84 at a radial dimension R₄, indicated by phantom line 85. The radial dimension R₄ is less than the radial dimension R₃. The peak and valley surfaces 82 and 84 are circumferentially spaced from one another by about 45 degrees about the axis A. The number of peak and valley surfaces 82 and 84 correspond to the number of locking assemblies 30.

The handle 28 is connected to the cam member 26 and is rotationally fixed thereto. In the embodiment shown, the handle 28 is integrally formed with the cam member 26, but could be a separate member is desired. The handle 28 is preferably easily reachable by the occupant of the seat 10 to operate the adjuster 20 by imparting rotation to the cam member 26, as will be discussed in detail below. The handle 28 or the cam member 26 may be spring biased by a spring element (not shown) for returning the cam member 26 to a desired position after the handle is released. Also, the adjuster 20 may include a stop and detent mechanism (not shown) for properly positioning and/or preventing undesirable movement of the cam member 26. The handle 28 may also include a locking mechanism (not shown) preventing the handle from being used until a release button or switch (not shown) is activated.

Instead of the handle 28, the adjuster 20 may include any mechanism for causing rotation of the cam member 26. For example, the cam member may be connected to a cable (not shown) which is pulled from a remote location. Alternatively, a motorized apparatus (not shown) may be connected to the cam member 26 for causing rotation thereof upon actuation of a switch connected to the motor.

The adjuster 20 further includes at least one locking assembly 30. In the embodiment shown in FIG. 2, the adjuster 20 may include up to four locking assemblies 30, circumferentially spaced apart from one another by about 90 degrees about the axis A. For simplicity, only one locking assembly is illustrated in FIG. 2, but it should be understood that any number of locking assemblies 30 may be incorporated into the adjuster 20. Broadly stated, the locking assemblies 30 selectively permit and prevent rotation of the outer member 22 relative to the inner member 24, thereby permitting adjustability of the angular position of the seat back 12 relative to the seat bottom 14. Preferably, all of the plurality of locking assemblies 30 are operable simultaneously. The use of a plurality of locking assemblies 30 helps assure that when in the locked position, the adjuster 20 will not slip causing unintentional motion of the seat back 12. Also, a plurality of locking assemblies helps to assure that under high loads, such as during an impact situation, the adjuster 20 will not cause the seat back 12 to move by an undesirable angular amount relative to the seat bottom 14. The adjuster 20 may include a plurality of substantially the same type of locking assemblies, or alternatively, a combination of different types of locking assemblies, as described herein, may be used.

As best shown in FIG. 3, the locking assembly 30 includes first and second wedge elements 90 and 92. The wedge elements 90 and 92 are disposed in the annular gap 62 between the inner surface 46 of the outer member 22 and the outer surface 56 of the inner member 24. The wedge elements 90 and 92 of the illustrated embodiment have a cylindrical shape. However, it should be understood that the wedge elements 90 and 92 may have any suitable shape, such as spherical or tapered wedge element-shaped, suitable for rotational motion within the annular gap 62. For example, the wedge elements 90 and 92 may be spherically shaped steel ball bearings. Alternatively, the wedge elements 90 and 92 may be substituted, as discussed herein with respect to the claims and description, with members having a non-rotatable shape, such as wedge shape, and being slidably disposed in the annular gap 62 movable between wedged and free positions within the annular gap 62. For reasons described in detail below, the wedge elements 90 and 92 are movable within the annular gap 62 between a wedged position, as shown in FIG. 3, and a free position, as shown in FIG. 5. Preferably, the annular gap 62 has a radial width ranging between a width less than the diameter of the wedge elements 90 and 92 to a width greater than the diameter of the wedge elements 90 and 92 due to the non-uniform radial dimension of the outer surface 56. In the wedged position, the wedge elements 90 and 92 are sandwiched between the inner surface 46 of the outer member 22 and the outer surface 56 of the inner member 24 such that there is no radial clearance between the wedge elements 90 and 92 and the surfaces 46 and 56. In the free position, the wedge elements 90 and 92 are disposed between the inner surface 46 of the outer member 22 and the outer surface 56 of the inner member 24 such that there is at least a small clearance between the wedge elements 90 and 92 and the surfaces 46 and 56. In the free positions, the wedge elements 90 and 92 are free to rotate within the annular gap 62, thereby permitting the outer member 22 to rotate relative to the inner member 24.

As shown in FIGS. 3 through 5, the locking assembly 30 further includes spring elements 96 and 98. The spring element 96 biases the wedge element 90 in a clockwise direction, as viewing FIGS. 2, 3, and 5 into its wedged position. The spring element 98 biases the wedge element 92 in a counter-clockwise direction, as viewing FIGS. 2, 3, and 5 into its wedged position. The spring elements 96 and 98 are disposed in the annular gap 62 and are attached to the outer surface 56 of the inner member 24, such as by fasteners 100. Alternatively, the spring elements 96 and 98 may not be connected to the inner member 24, and instead simply be positioned within or out of the annular gap 62. For example, a common spring element may be used for biasing adjacent wedge elements 90, 92 from adjacent locking assemblies 30. It should be understood that the spring elements 96 and 98 may have any suitable shape for biasing the wedge elements 90 and 92 into their respective wedged positions.

The locking assembly 30 further includes an actuation mechanism in the form of a resilient member or clip 102. The clip 102 includes a base portion 104 engaged with the outer surface 80 of the cam member 26. The clip 102 further includes a pair of engagement portions 106 connected to the base portion 104 via arm portions 108. The engagement portions 106 extend outwardly from the arm portions 108 and are positioned adjacent the wedge elements 90 and 92. In the wedged positions of the wedge elements 90 and 92, the engagement portions 106 may or may not come into contact with the wedge elements 90 and 92. As will be explained below, the clip 102 is movable or deflectable by the cam member 26 from a primary position, as shown in FIG. 3, to an engaged position, as shown in FIG. 5, to move the wedge elements 90 and 92 to their respective free positions. It should be understood that the clip 102 may have any suitable shape capable of being actuated by the cam member 26 for moving the wedge elements 90 and 92 to their free positions.

As can be seen best from FIG. 4, it is preferred that wedge elements 90 and 92, the cam surfaces 46 and 56 engaging the wedge element 90 and 92, and the cam member 26 are aligned in a plane B perpendicular to the axis A. This configuration provides for a relative thin adjuster 20.

The operation of the adjuster 20 will now be explained. In normal use, the seat back 12 is rotationally fixed with respect to the seat bottom 14, and the adjuster 20 is in its normal or locked position as shown in FIGS. 2-4. Thus, the seat back 12 is locked or prevented from rotational movement relative to the seat bottom 14. For ease of description, the adjuster 20 will be described as the inner member 24 being connected to the seat bottom 14, and therefore stationary, and the outer member 22 being connected to the seat back 12. In this normal position, the wedge elements 90 and 92 are in their wedged positions. In the wedged positions, the wedge elements 90 and 92 are sandwiched between the inner surface 46 of the outer member 22 and the outer surface 56 of the inner member 24 such that there is no radial clearance between the wedge elements 90 and 92 and the surfaces 46 and 56. Any force acting on the seat back 12 in an attempt to move the outer member 22 in a counter-clockwise direction, as viewing FIGS. 2 and 3, is prevented from doing so due to the wedge element 92 being pinched or wedged in the annular gap 62. Imparting rotational movement of the outer member 22 in the counter-clockwise direction will attempt to roll the wedge element 92 counter-clockwise but is unable to do so due to the narrowing of the annular gap 62. The portion of the annular gap 62 to the left of the wedge element 92 has a radial width which is less than the diameter of the wedge element 92. Similarly, any force acting on the seat back 12 in an attempt to move the outer member 22 in a clockwise direction, as viewing FIGS. 2 and 3, is prevented from doing so due to the wedge element 90 being pinched or wedged in the annular gap 62. Imparting rotational movement of the outer member 22 in the clockwise direction will attempt to roll the wedge element 90 clockwise but is unable to do so. The spring elements 96 and 98 assist in maintaining the wedge elements 90 and 92 in their wedged positions and help prevent the wedge elements 90 and 92 from slipping into the portion of the annular gap 62 having a radial width greater than the diameter of the wedge elements 90 and 92. The portion of the annular gap 62 to the right of the wedge element 90 has a radial width which is less than the diameter of the wedge element 92. Although the sloping cam surfaces are shown and described on the outer surface 56 of the inner member 24, it should be understood that the adjuster 20 could be configured such that sloping cam surfaces are formed on inner surface 46 of the outer member 22. In the locked position of the adjuster 20 as shown in FIGS. 2 and 3, the cam member 26 is oriented such that the valley surface 84 is engaged with the base portion 104 of the clip 102. Also, in the locked position of the adjuster 20, the clip 102 is in its primary position such that the engagement portions 106 do not urge the wedge elements 90 and 92 from their wedged positions.

When the occupant of the seat 10, or another user, wants to adjust the angular position of the seat back 12 relative to the seat bottom 14, the user pulls on the handle 28, thereby imparting a rotational force on the cam member 26. In the embodiment of the cam member 26 illustrated in FIGS. 2-5, the cam member 26 can be rotated in either direction. The cam member 26 is rotated via the handle 28 until a peak surface 82 is engaged with the base portion 104, as shown in FIG. 5. In the embodiment shown, the cam member 26 is rotated approximately 45 degrees. Of course, the peak and valley surfaces 82 and 84 of the cam member 26 could be configured such that any desired degree of rotation will be sufficient depending on the location and number peak and valley surfaces 82 and 84. Since the peak surface 82 has a larger radial dimension than the valley surface 84, the base portion 104 will be moved radially outwardly relative to the axis A. Movement of the base portion 104 causes the arm portions 108 to also move radially outwardly. Thus, the cam member 26 imparts a radially directed force to the base portion 104. Although the radially directed force is substantially radial due to the shape and location of the cam member 26 and the base portion 104 of the clip 102, it should be understood that the radially directed force may be offset from a true radial direction. For example, if the cam member 26 and the base portion 104 had engaging surfaces which were sloped, the force exerted by the cam member 26 would have some radially directed component as well as a force component perpendicular to the radial component. Thus, the term radially directed force is not limited to a force solely in the true radial direction but may be some component thereof. Since the upper portion of the arm portions 108 engage the inner surface 46 of the outer member 22 at an angle, as shown in FIG. 5, the engagement portions 106 will move outwardly relative to the base portion 104 in the annular gap 62. This movement of the engagement portions 106 force the wedge elements 90 and 92 out from their wedged positions to their free positions. Note that the spring force exerted by the spring elements 96 and 98 will be overcome by the movement of the wedge elements 90 and 92. Since the wedge elements 90 and 92 are now in their free positions, the outer member 22 is free to rotate relative to the inner member 24, and thus the seat back 12 is free to rotate relative to the seat bottom 14. It is noted that the clip 102 functions as an actuation mechanism directly moving the wedge elements 90 and 92 in response to the radially directed force imparted thereon by the cam member 26.

Once the seat back 12 is in its desired position, the user, via the handle 28, moves the cam member 26 back to its position as shown in FIG. 3 such that the base portion 104 of the clip 102 engages a valley surface 84. This movement will in turn cause the wedge elements 90 and 92 to return to their wedged positions since the engagement portions 106 of the clip 102 are retracted. The spring elements 96 and 98 assist in pushing the wedge elements 90 and 92 into their wedged positions.

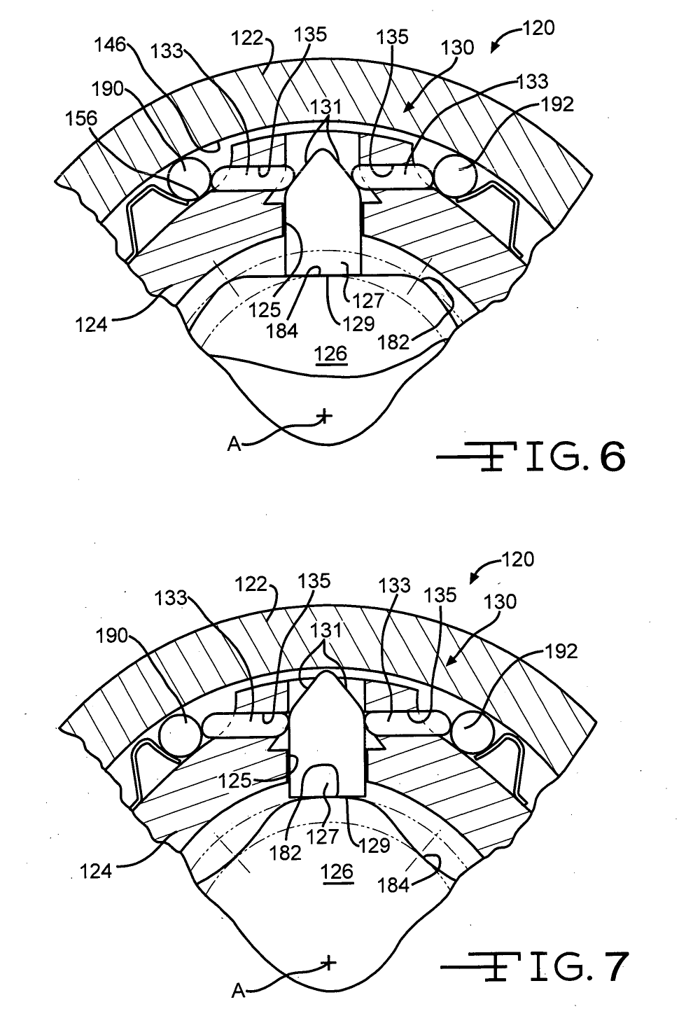

There is illustrated in FIGS. 6 and 7 an alternate embodiment of an adjuster 120. Many of the components of the adjuster 120 illustrated in FIGS. 6 and 7 are similar in structure and function to corresponding components of the adjuster 20 shown in FIGS. 3 and 5. Therefore, such corresponding components are indicated by similar terms and reference numbers in these Figures, but with the reference numbers of the adjuster 120 having one-hundred prefixes.

The primary difference of the adjuster 120 is the use of a different locking assembly 130. The adjuster 120 has an outer member 122, and inner member 124, and a cam member 126 which function in a similar manner as the outer member 22, inner member 24, and the cam member 26 discussed above. The inner member 124 includes a slot 125 for receiving a ram 127 slidably disposed for reciprocating movement therein. The ram 127 includes a first end having a base portion 129 engaged with the cam member 126. The other end of the ram 127 includes a pair of sloping surfaces 131. Each of the sloping surfaces 131 is engaged with a plunger 133 slidably disposed in slots 135 formed the inner member 124. One end of each of the plungers 133 engages with a sloping surface 131 of the ram 127, and the other end of each of the plungers 133 is engageable with a respective wedge element 190 and 192. The plungers 133 can be configured to slide along any angle which enables the plungers 133 to move the wedge elements 190 and 192 from their wedged position to their free positions.

In operation, the adjuster 120 is normally in its locked position as shown in FIG. 6. In this locked position, the base portion 129 of the ram 127 engages with a valley surface 184 of the cam member 126. The locking assembly 130 may include one or more spring elements (not shown) for biasing the plungers away from the wedge elements 190 and 192. The plungers 133 are retracted towards one another such that the wedge elements 190 and 192 are permitted to be positioned in their wedged positions pinched between an outer surface 156 of the inner member 124 and an inner surface 146 of the outer member 122. The spring elements 196 and 198 assist in maintaining the wedge elements 190 and 192 in their wedged positions.

To adjust the seat back 12, the cam member 126 is rotated to the position shown in FIG. 7 such that the peak surface 182 engages the base portion 129 of the ram 127, pushing the ram 127 radially outwardly. This movement of the ram 127 causes the plungers 133 to move outwardly away from the ram 127 via the sliding motion of the sloping surfaces 131 engaging with the plungers 133. Movement of the plungers 133 pushes the wedge elements 190 and 192 to their free positions. Since the wedge elements 190 and 192 are now in their free positions, the outer member 122 is free to rotate relative to the inner member 124, and thus the seat back 12 is free to rotate relative to the seat bottom 14. It is noted that the ram 127 functions as an actuation mechanism indirectly moving the wedge elements 190 and 192 via the plungers 133 in response to the radially directed force imparted thereon by the cam member 126. Once the seat back 12 is in its desired position, the cam member 126 is moved back to its position as shown in FIG. 6 such that the base portion 129 of the ram 127 engages the valley surface 184, and the wedge elements 190 and 192 are back in their wedged positions.

One of the advantages of the adjuster 120 compared to the adjuster 20 is that a stronger force may be able to be applied to the wedge elements 190 and 192 to move them from out of their wedged positions. In some situations, such as when the occupant of the seat 10 is leaning back on the seat back 12, it may take a relatively strong force to move the wedge elements 190 and 192 from out of their pinched, wedged positions.

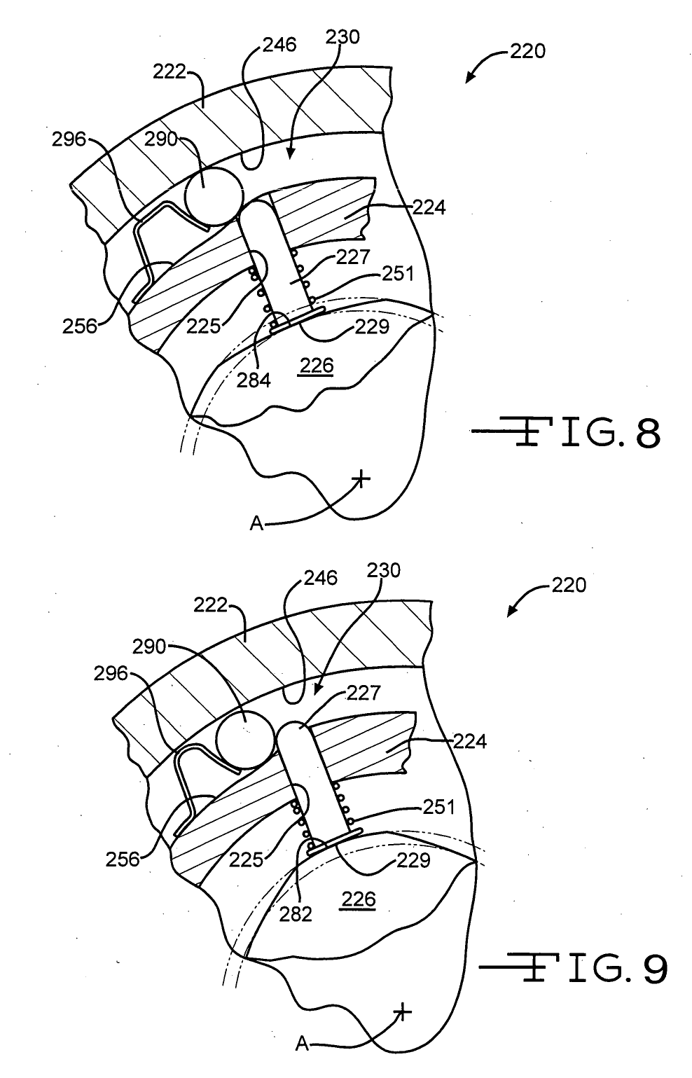

There is illustrated in FIGS. 8 and 9 another alternate embodiment of an adjuster 220. Many of the components of the adjuster 220 illustrated in FIGS. 8 and 9 are similar in structure and function to corresponding components of the adjusters 20 and 120. Therefore, such corresponding components are indicated by similar terms and reference numbers in these Figures, but with the reference numbers of the adjuster 220 having two-hundred prefixes.

The primary difference of the adjuster 220 is the use of a different locking assembly 230. The adjuster 220 has an outer member 222, and inner member 224, and a cam member 226 which function in a similar manner as the outer member 22, inner member 24, and the cam member 26 discussed above. Note that the locking assembly 230 is shown and described as to only one wedge element 290 corresponding to the wedging and prevention of the adjuster 220 to move in one rotational direction, but it should be understood that the same structural components may be used in cooperation with the other wedge element (not shown) for use in wedging and prevention of the adjuster 220 to move in the other rotational direction. The inner member 224 includes a slot 225 for receiving a plunger 227 slidably disposed therein. The plunger includes a first end having a base portion 229 engaged with the cam member 226. The other end of the plunger 227 engages the wedge element 290. A return spring 251 is provided for biasing the plunger 227 away from the wedge element 190.

In operation, the adjuster 220 is normally in its locked position as shown in FIG. 8. In this locked position, the base portion 229 of the plunger 227 engages with a valley surface 284 of the cam member 226. The plunger 227 is retracted away from the wedge element 290 and the wedge element 290 is permitted to be positioned in its wedged position pinched between an outer surface 256 of the inner member 224 and an inner surface 246 of the outer member 222. A spring element 296 assists in maintaining the wedge element 290 in its wedged position.

To adjust the seat back 12, the cam member 226 is rotated to the position shown in FIG. 9 such that the peak surface 282 engages the base portion 229 of the plunger 227 pushing the plunger 227 radially outwardly. This movement of the plunger 227 pushes the wedge element 290 to its free position. Since the wedge element 290 is now in its free position, the outer member 222 is free to rotate relative to the inner member 224, and thus the seat back 12 is free to rotate relative to the seat bottom 14. Once the seat back 12 is in its desired position, the cam member 226 is moved back to its position as shown in FIG. 8 such that the base portion 229 of the plunger 227 engages the valley surface 284, and the wedge element 290 is back in its wedged position.

Although the locking assembly 230 is described as using the cam member 226 to provide a mechanical connection for moving the plunger 227, the locking assembly 130 could be configured without the cam member 226 utilizing another actuator (not shown) for moving the plunger 227. For example, the actuator could be a solenoid actuated mechanism (not shown), and thus the locking assembly would be electrically actuated.

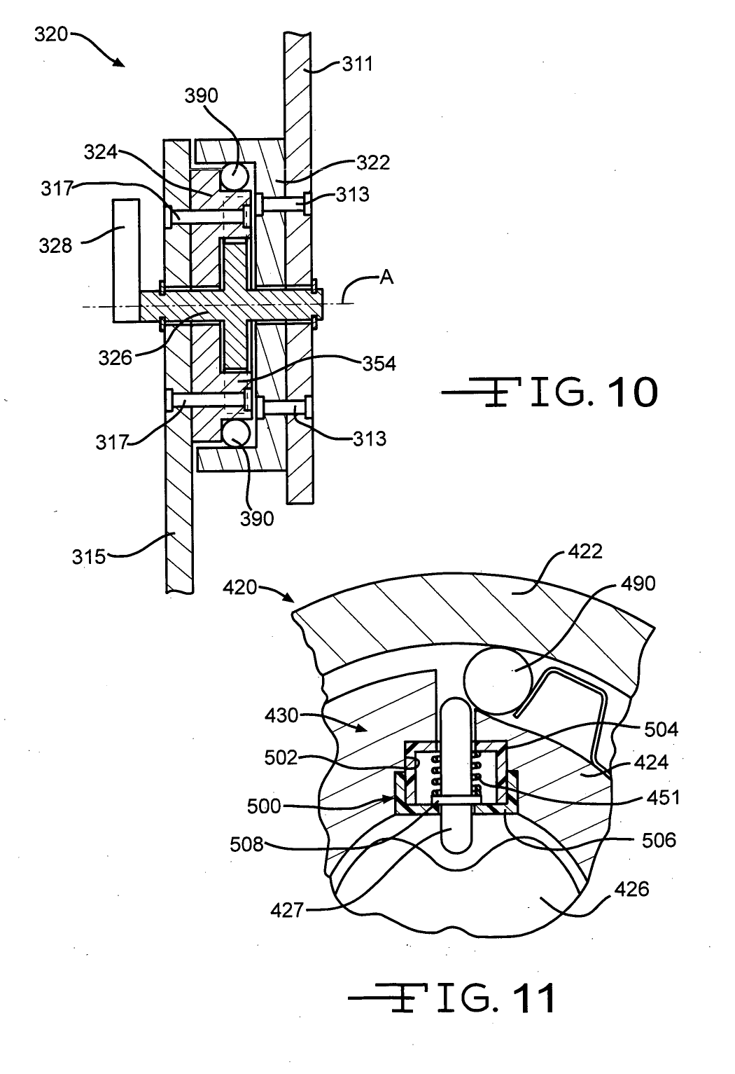

There is illustrated in FIG. 10 another alternate embodiment of an adjuster 320. Many of the components of the adjuster 320 illustrated in FIG. 10 are similar in structure and function to corresponding components of the adjusters 20, 120 and 220. Therefore, such corresponding components are indicated by similar terms and reference numbers in these Figures, but with the reference numbers of the adjuster 320 having three-hundred prefixes.

The adjuster 320 includes an outer member 322, and inner member 324, and a cam member 326. One of the differences of the adjuster 320 is that the inner member 324 is generally of a more robust design with respect to the radial forces imparted by wedge elements 390. An outer flange 354 of the inner member 324 has an increased thickness. Another difference is that that the wedge elements 390 are spherical in shape.

The outer member 322 is connected to a bracket 311. The bracket 311 may be connected to the seat back 12 or may be part of the frame structure of the seat back 12 itself. The outer member 322 may be connected to the bracket 311 by rivets 313 or any other suitable fastener. The inner member 324 is connected to a bracket 315. The bracket 315 may be connected to the seat bottom 14 or may be part of the frame structure of the seat bottom 14 itself. The inner member 324 may be connected to the bracket 315 by rivets 317 or any other suitable fastener. Note that the details of a locking assembly are not illustrated in FIG. 10. Optionally, the adjuster 320 may include thrust washers and or bushings (not shown).

There is illustrated in FIG. 11 an alternate embodiment of a locking assembly 430 of an adjuster 420. Many of the components of the adjuster 420 illustrated in FIG. 11 are similar in structure and function to corresponding components of the locking assemblies and adjusters described above. Therefore, such corresponding components are indicated by similar terms and reference numbers in these Figures, but with the reference numbers of the adjuster 420 having four-hundred prefixes.

The adjuster 420 includes an outer member 422, and inner member 424, and a cam member 426. The locking assembly 430 includes a wedge element 490 which is selectively moved by a plunger 427. The plunger 427 is preferably housed in a cartridge assembly 500. The design of the cartridge assembly 500 has the advantage of simple assembly of multiple plungers 427 onto the inner member 424. The cartridge assemblies 500 may be previously manufactured and assembled, and then simply installed into a bore 502 formed in the inner member 424. The cartridge assembly 500 includes first and second housings 504 and 506. The plunger 427 includes an outwardly extending flange 508 formed therein. A return spring 451 is provided for biasing the plunger 427 away from the wedge element 490. One end of the spring 451 acts against the flange 508, and the other end acts against the first housing 504. The housings 504 and 506 may have any suitable shape for retaining the plunger 427 and spring 451, and for being installed on the inner member 424.

The locking assembly 430 is shown in its locked position such that the wedge element 490 is pinched between the outer and inner members 422 and 424. It is noted that the plunger 427 need not contact the wedge element 490 when in its locked position. This non-contact may help in reducing noise and vibration of the adjuster 420 and locking assembly 430. It is also noted that the plunger 427 need not contact the cam member 426 when in its locked position. This non contact may also help in reducing noise and vibration of the adjuster 420 and locking assembly 430.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A rotary adjuster comprising:
a first member defining a cam surface;
a second member rotatably mounted relative to said first member about an axis, said second member defining a cam surface;
a first wedge element selectively movable between a wedged position engaging said cam surfaces to prevent rotation of said second member relative to said first member in a first rotational direction, and a free position permitting movement of said second member relative to said first member;
a second wedge element selectively movable between a wedged position engaging said cam surfaces to prevent rotation of said second member relative to said first member in a second rotational direction opposite said first rotational direction, and a free position permitting movement between said second member relative to said first member; and
an actuation mechanism responsive to a radially directed force for moving at least one of said first and second wedge elements from said wedged position to said free position, thereby allowing the rotational position of said second member to be adjusted relative to said first member.

2. The adjuster of claim 1, wherein said actuation mechanism simultaneously moves said first and second wedge elements from said wedged positions to said free positions.

3. The adjuster of claim 1, wherein said radially directed force is provided by a rotating cam member engaged with said actuation mechanism.

4. The adjuster of claim 3, wherein said cam surface of said first member is defined as a generally outer circumferential surface formed in said first member,
and wherein said cam surface of said second member is defined as a generally inner circumferential surface formed in said second member,
such that said cam surfaces, said first and second wedge elements, and said cam member are aligned in a plane perpendicular to the axis.

5. The adjuster of claim 3, wherein said cam member rotates about the axis.

6. The adjuster of claim 5, wherein said cam member has at least a pair of circumferentially extending surfaces having different radial dimensions relative to the axis.

7. The adjuster of claim 3, wherein said cam member is manually rotatable by a handle connected thereto.

8. The adjuster of claim 1, wherein said actuation mechanism includes a resilient member selectively engaged with said first and second wedge elements, said resilient member deflectable between a first position permitting said at least one of said first and second wedge elements to be in said wedged position, and a second position moving said at least one of said first and second wedge elements to said free position.

9. The adjuster of claim 1, wherein said actuation mechanism is slidably disposed in one of said first and second members for reciprocating motion.

10. The adjuster of claim 9, wherein said actuation mechanism is slidably disposed along a radial direction relative to said axis.

11. The adjuster of claim 9, wherein said actuation mechanism includes an end which engages said at least one of said first and second wedge elements for moving said at least one of said first and second wedge elements to its respective free position.

12. The adjuster of claim 9, further including first and second plungers slidably disposed in one of said first and second members, said first plunger engageable with said first wedge element, said second plunger engageable with said second wedge element, wherein said actuation mechanism is a ram having first and second sliding surfaces engageable with said first and second plungers such that radial movement of actuation mechanism causes said first and second plungers to engage said first and second wedge elements.

13. The adjuster of claim 1, further including a spring member biasing said at least one of said first and second wedge elements to its respective wedged position.

14. The adjuster of claim 1, wherein said cam surface of said first member is defined as a generally outer circumferential surface formed in said first member, and wherein said cam surface of said second member is defined as a generally inner circumferential surface formed in said second member.

15. The adjuster of claim 1, wherein said first and second members are rotatably mounted about the axis.

16. The adjuster of claim 1, wherein said adjuster rotatably adjusts a first seat portion relative to a second seat portion.

17. The adjuster of claim 16, wherein said first seat portion is a seat back, and wherein said second seat portion is a seat bottom.

18. The adjuster of claim 1, wherein said first and second wedge element are rotatably disposed in said first and second gap.
